(19) United States
(12) Patent Application Publication
(10) Pub. No.: US 2026/0288523 A1
(43) Pub. Date: Sep. 24, 2026

(54) System and method for an event-specific resource configuration of an object

(71) Applicant: Bank of America Corporation, Charlotte, NC (US)

(72) Inventors: Nathan L. Macaluso, Denver, CO (US); Marshall A. Johnson, Summit, NJ (US); Sandra L. Dube, Salt Lake City, UT (US); Ana Maxim, Arlington, VA (US); Manu Kurian, Dallas, TX (US)

(21) Appl. No.: 19/085,837

(22) Filed: Mar. 20, 2025

(51) Int. Cl. G06F 9/50

(52) U.S. Cl. CPC G06F 9/5027

(57) ABSTRACT

A system to configure event-specific resource allocations across objects is disclosed. The system retrieves structured data and unstructured data from a data lake. The system extracts historical resource transfer events with respect to an object from the structured data and extracts an upcoming event from the unstructured data. In response, the system extrapolates a correlation that indicates the upcoming event will impact an upcoming resource transfer for the object. The system derives a resource impact index that indicates the percentage of the object requiring a set of resources due to the upcoming event. If the resource impact index is more than a threshold percentage, the system generates an event-specific resource allocation recommendation for the object and communicate to a user device. The system executes an event-specific allocation command code that causes a processor to provision indicated resources to the object.

### TECHNICAL FIELD

The present disclosure relates generally to network communication, and more specifically to a system and method for an event-specific resource configuration of an object.

### BACKGROUND

In some cases, some devices may require certain resources to operate or function. In some cases, some devices may go through wear and tear, and therefore need certain resources for replenishment, replacement, or maintenance. If devices do not receive or be allocated with the associated resources, their operations may be interrupted or they may not operate as efficiently as intended.

### SUMMARY

The disclosed system, described in the present disclosure, is particularly integrated into practical applications to provide technological improvements to conventional physical and digital resource allocation and distribution techniques.

Conventional systems typically rely on static resource allocations on a fixed schedule. Thus, the conventional systems are not configured to adapt to fluctuations in upcoming resource needs for a given object. Further, the conventional systems are not configured to utilize sensor data from sensor circuits associated with the objects to extrapolate meaningful insight into their resource usage patterns, resource needs, and resource depletion rates. Thus, with conventional systems, an object in need of resources—either digital resources, such as computing or network resources; and/or physical resources, such as new batteries, tires, a new microchip, etc., may suffer from insufficient resources, which, leads to interruptions to operations of the object. This further leads to downtime, reduced performance index, and distributions in network communications, among other deficiencies for the object.

The disclosed system is configured to provide a technical solution to these and other technical problems in conventional resource allocation techniques. The technical advantages and improvements over the conventional techniques are described below in conjunction with certain embodiments of the disclosed system.

In some embodiments, the disclosed system is configured to establish an interconnected network of electronic devices (e.g., including electronic objects, user devices, and servers) to facilitate physical and/or digital resource configurations across the electronic devices. In some examples, an electronic object may include sensor circuits that capture relative sensor data that provide operational conditions of the respective electronic object over time. The server may obtain the plurality of sensor data from multiple sensor circuits and extrapolate resource usage patterns, resource consumption, resource depletion rate, and other information about the electronic objects. The server may use this information to analyze the current resource usage pattern for each electronic object and predict or infer a time window in the future to allocate additional resources to each electronic object. For example, the server may compare the historical resource consumption data with the current resource usage pattern for a given electronic object and determine whether the given electronic object requires additional resources to operate without interruptions. If the server anticipates that an electronic object requires additional resources in a time window in the future, the server may generate a resource allocation scheme to allocate the additional resources to the object within the tine window in the future. In some embodiments, the server may execute the resource allocation scheme by, for example, physically allocating the additional resources to the electronic object when within the anticipated time window. For example, if the electronic object is a computing device that requires additional processing power or memory capacity, the server may dynamically provision physical computing resources from a distributed cloud computing system in a server farm (e.g., virtual machine resources from a recommended entity) to the computing device. Thus, the disclosed system enables the electronic devices to continue their operations as intended without interruptions caused by a lack of resources—which would occur with the static resource allocation method of conventional systems.

By leveraging structured and unstructured data sources, including historical resource consumption patterns and real-time sensor data, the system is able to refine resource distribution strategies to reduce resource distribution inefficiencies across objects. One downstream technical advantage of this approach is the reduction of resource waste and over-provisioning, which are common drawbacks in conventional resource allocation systems. For example, rather than allocating a fixed amount of resources, which can lead to resource overutilization and underutilization, the disclosed system dynamically determines a particular amount of resources to be allocated to a given object based on historical and real-time resource demand trends and fluctuations. This is particularly advantageous in system where resources are limited.

In some embodiments, the system may provide resource allocation recommendations for multiple objects at a macro scale. For example, the server may analyze aggregated resource consumption data across multiple objects to identify broader resource allocation trends and inefficiencies in resource allocations or distributions. In response, the server may generate a resource allocation and distribution scheme that improves resource usage and utilization across the interconnected objects. One downstream technical advantage of this approach is the ability to dynamically rebalance resources across objects based on shifting resource needs or demands. By continuously monitoring usage trends across multiple objects, the system proactively redistributes surplus resources from underutilized objects to those experiencing higher demand. This ensures that resources are allocated where they are needed most, rather than following static or pre-defined schedules that may not reflect real-time conditions. In other words, the system balances resources across the objects, such that no object is undersupplied with resources while other objects have excess or underutilized resources. For example, the system may distribute the resources across the objects such that no object is undersupplied or has underutilized resources. This, in turn, leads to increasing resource utilization for all objects.

In some embodiments, operations described with respect to electronic objects may apply to non-electronic objects. For example, the system may monitor and analyze resource consumption patterns for non-electronic objects, such as mechanical devices, household appliances, or consumable goods. The disclosed system may extrapolate or infer a replacement schedule based on historical usage trends for a given object. This leads to improved resource availability by facilitating that necessary physical resources are allocated before they are depleted. The downstream technical advantages of this approach include reducing operational downtime by proactively ensuring that required resources are replenished before a shortage occurs and dynamically adjusting resource allocation based on external factors such as supply chain conditions, seasonal demand fluctuations, and unexpected disruptions.

Further, the disclosed system provides additional technical improvements over conventional resource allocation systems by implementing a dynamic, event-specific techniques for resource configuration (distribution and allocation) that proactively adapts to upcoming events. The current resource allocation systems that use static and fixed resource allocation at predefined intervals are not configured to consider upcoming fluctuations in resource needs of objects due to upcoming events (e.g., seasonal, regional, weather-based, or user-specific events). Thus, the conventional resource allocation systems suffer from reduced resource utilization and poor load balancing among objects. Certain technical improvements of dynamic resource allocation achieved by the disclosed system includes optimized resource utilization, improve scalability of sub-systems, flexibility to adapt to changing workloads and needs, reduced resource waste, and the ability to allocate resources based on real-time needs, ultimately leading to better application performance and responsiveness. The disclosed system can scale up or down its resource usage automatically to handle fluctuating workloads, allowing for efficient handling of traffic spikes without manual intervention. Real-time adjustments to resource allocation can enhance application performance by ensuring critical tasks have the necessary resources readily available. Dynamic allocation provides the ability to quickly adapt to changing requirements or priorities within an application or sub-system. By dynamically allocating resources based on current demands, developers and system administrators can ensure that tasks are executed efficiently. Consequently, this leads to improved performance and responsiveness.

The disclosed system is configured to utilize external factors that affect resource needs for objects, such as weather data, news feed, user-specific data, and other type of data to extrapolate fluctuations in resource needs for an extended period of time in the future per object, per user, and/or per region. Thus, the disclosed system is configured to extrapolate non-obvious correlations among the external factors that affect the future resource needs to derive meaningful insight from them and allocate (or reallocate) resources across objects to consider the upcoming resource needs. For example, the disclosed system may analyze the weather data and/or news feed and extrapolate that there will be a snowstorm in a particular geographical location. The system may also analyze historical resource allocation for particular object (e.g., computer components, tires of a vehicle, etc.) in that particular geographical location. In response, the system may determine that the upcoming snowstorm may cause delays in transportation of the particular object from entities (e.g., suppliers) and therefore, shortage in the supply of particular object and an increased demand for the particular object. In response, the system may determine the correlation between the upcoming snowstorm with the resource demand for the particular object. Thus, the system may predict a spike in resource needs for the object in the particular geographical location and generate an event-specific resource allocation recommendation to preemptively allocate additional resources for the object. The system may derive the quantity of resources to be allocated for the object, a timeframe to allocate the resources for the object, an entity that provides the object, among others. In response, the system may execute the resource allocation command code that, upon execution, causes the determined resources to be allocated for the object within the prescribed time window.

The system is configured to consider external factors that affect the resource needs for objects and increase the resource allocation utilization across objects. This, in turn, reduces the distributions and downtime for objects that rely on resources to operate or be operated. In some examples, assuming that the objects include computer components for a data center, by implementing the system, the upcoming resource needs for the data center to operate without interruptions in its operations due to an event (e.g., seasonal, regional, weather-based, etc.) is extrapolated from the historical and current weather data, resource consumption pattern, news feed, among other types of data. In response, the system may generate an event-specific resource configuration to preemptively anticipate the required quantity of computer components, future time window, and an entity that provides the computer components. The system may execute the resource allocation command code that, upon execution, allocates the determined computer components to the data center within the prescribed time window. In this example, by proactively managing resource allocation, the system improves the operational performance and stability of the data center, and reduces the disruptions caused by upcoming events. Further, the system reduces latency in the data center’s operations and overloads in operations of the data center. Further, the system reduces component failure that would occur if additional resources were not provided to the data center and the current components of the data center are overburdened with excess computational tasks. Thus, the system improves the reliability of the data center by providing resources ahead of the time of the resource needs.

Resource configuration across a network of interconnected devices

In some embodiments, a system comprises a memory, a first sensor circuit, and a processor. The memory is configured to store resource consumption data associated with a first electronic device, wherein the resource consumption data indicates historical records of physical resource consumption by the first electronic device over time. The first sensor circuit is associated with the first electronic device, and configured to capture sensor data that indicates at least one operational parameter of the first electronic device over time, wherein the at least one operational parameter comprises a physical characteristic of the first electronic device that affects resource consumption of the first electronic device.

The processor is operably coupled with the memory and the first sensor circuit. The processor is configured to electronically receive, via a network and from a user device, a resource allocation metric that indicates a prioritization of resource allocation across a plurality of electronic devices to meet predefined criteria, wherein each of the plurality of electronic devices is communicatively coupled with the user device. The processor is further configured to automatically retrieve, via a network and from the user device, transmission activity data that indicates a set of resource transfer events associated with the plurality of electronic devices in response to electronically receiving the resource allocation metric. The processor is further configured to extrapolate, from the resource consumption data, an expected resource usage cycle associated with the first electronic device, wherein the expected resource usage cycle indicates a recurring pattern of resource usage by the first electronic device at every predefined interval. The processor is further configured to extrapolate, from the sensor data, a current resource usage rate associated with the first electronic device, wherein the current resource usage rate indicates a rate of depletion in resource usage by the first electronic device. The processor is further configured to derive, based at least in part upon the current resource usage rate, the expected resource usage cycle, and the transmission activity data, a future time window in which additional physical resources will be required for the first electronic device to operate without disruption while the criteria is met. The processor is further configured to in response to deriving the future time window, generate a first resource allocation recommendation that comprises the derived future time window to allocate the additional physical resource to the first electronic device. The processor is further configured to electronically communicate the first resource allocation recommendation to the user device. The processor is further configured to electronically receive an electronic message that indicates feedback on the first resource allocation. The processor is further configured to adjust a resource allocation schedule according to the feedback on the first resource allocation. The processor is further configured to adjust a resource allocation schedule according to the feedback on the first resource allocation in response to electronically receiving the electronic message.

An event-specific resource configuration for an object in response to an upcoming event

In some embodiments, the system may include a memory operably coupled with a processor. The memory stores a data lake that includes structured data and unstructured data. The structured data comprises historical resource transfer events associated with a first object, wherein each of the historical resource transfer events indicates a quantity of physical resources consumed with respect to a first object over time. The unstructured data comprises news reports, wherein the news reports comprise text that indicate events with respect to one or more geographic locations.

The processor is configured to electronically retrieve, via a network and from the data lake, the structured data and the unstructured data. The processor is further configured to extract, from the structured data, the historical resource transfer events. The processor is further configured to extract, from the unstructured data, an upcoming event. In some embodiments, extracting the upcoming event comprises convert the text into a tokenized dataset, wherein each word within the text is converted into a respective numerical representation that indicates at least one of a meaning of a respective word or a relationship between the respective word and other words within the text; extract context of the text based at least in part upon the tokenized dataset; and determine, based at least in part upon the extracted context, a reference to an upcoming event predicted to occur within a future time window.

The processor is further configured to extrapolate, from the extracted historical resource transfer events and determined reference to the upcoming event, a correlation that indicates the upcoming event will impact an upcoming resource transfer for the first object. The processor is further configured to derive, based at least in part upon the extrapolated correlation, a resource impact index that indicates a percentage of the first object requiring a first set of resources due to the upcoming event. The processor is further configured to determine that the resource impact index is more than a threshold percentage. in response to determining that the resource impact index is more than the threshold percentage, the processor is further configured to generate a first event-specific resource allocation recommendation for the first object, wherein the first event-specific resource allocation recommendation comprises a quantity of the first set of resources to be allocated to the first object; electronically communicate the first event-specific resource allocation recommendation to a user device; electronically receive an electronic message that indicates feedback on the first event-specific resource allocation recommendation; and in response to electronically receiving the electronic message, adjust the first event-specific resource allocation recommendation according to the feedback. In some embodiments, adjusting the first event-specific resource allocation recommendation comprises: extrapolate, from the feedback that a second set of resources is to be allocated to the first object; in response to extrapolating, from feedback, that the second set of resources is to be allocated to the first object, generate an event-specific resource allocation command code that, upon execution, causes the processor to provision the second set of resources to the first object; and execute the event-specific resource allocation command code.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to allocate resources across objects and allocate resources for an object in response to an upcoming event;

FIG. 2 illustrates an example operational flow of the system of FIG. 1 to allocate resources across objects;

FIG. 3 illustrates an example flow chart of a method of the system of FIG. 1 to allocate resources across objects; and

FIG. 4 illustrates an example flow chart of a method of the system of FIG. 1 to allocate resources for an object in respond to an upcoming event.

### DETAILED DESCRIPTION

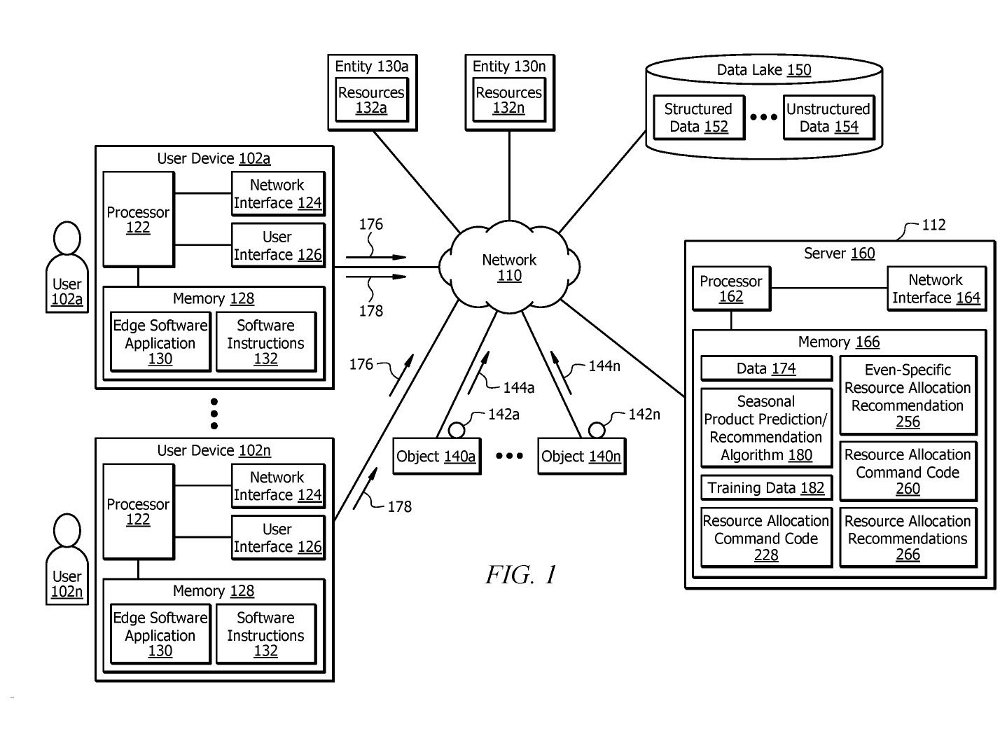

As described above, previous technologies fail to provide efficient and reliable solutions for efficiently and effectively implementing resource configurations for objects. Embodiments of the present disclosure and its advantages may be understood by referring to FIGS. 1-4. FIGS. 1-4 are used to describe systems and methods for efficiently and effectively implementing resource configurations for objects and implementing event-specific resource configurations for objects in respond to an upcoming event, according to some embodiments.

### System overview

FIG. 1 illustrates an embodiment of a system 100 that is generally configured for sensor data-based resource configuration and analysis across a network of interconnected objects, including electronic and non-electronic devices. In some embodiments, the system 100 comprises a server 160 communicatively coupled with one or more user devices 120a-b, one or more entities 130a-n, one or more electrical objects 140a-n, and a data lake 150 via a network 110. The network 110 enables the communication among the components of the system 100. Each user device 120 (e.g., each of user devices 120a-n) may be used by users 102 to communicate with other devices and provide data to the server 160. Each entity 130 (e.g., each of entities 130a-n) may be an organization, such as a data or product provider that provides associated services and/or products to users 102. The data lake 150 may store information that may be used by the server 160 to perform one or more of its operations described herein. The server 160 may be configured to analyze historical and current physical and digital resource consumption patterns across multiple objects 140a-n, receive a preconfigured resource allocation metric 176 from a user device 120, generate a resource distribution and allocation scheme (e.g., resource configuration or recommendation) for the objects 140a-n based on the preconfigured resource allocation metric and the resource consumption patterns, and execute the generated resource distribution and allocation scheme. The server 160 may further adjust future resource allocation and distribution for one or more objects 140a-n based on resource availability and further adjustments to the resource allocation metric 176. In other embodiments, system 100 may not have all of the components listed and/or may have other elements instead of, or in addition to, those listed above.

In general, the disclosed system 100 provides technological improvements to conventional physical and digital resource allocation and distribution techniques. Conventional systems typically rely on static resource allocations on a fixed schedule. Thus, the conventional systems are not configured to adapt to fluctuations in upcoming resource needs for a given object 140. Further, the conventional systems are not configured to utilize sensor data from sensor circuits associated with the objects 140a-n to extrapolate meaningful insight into their resource usage patterns, resource needs, and resource depletion rates. Thus, with conventional systems, an object 140 in need of resources—either digital resources, such as computing or network resources; and/or physical resources, such as new batteries, tires, a new microchip, etc.) may suffer from insufficient resources, which, leads to interruptions to operations of the object 140. This further leads to downtime, reduced performance index, and distributions in network communications, among other deficiencies for the object 140.

The disclosed system 100 is configured to provide a technical solution to these and other technical problems in conventional resource allocation techniques. The technical advantages and improvements over the conventional techniques are described below in conjunction with certain embodiments of the disclosed system.

In some embodiments, the disclosed system 100 is configured to establish an interconnected network of electronic devices (e.g., including electronic objects 140a-n, user devices 120a-n, and server 160) to facilitate physical and/or digital resource configurations across the electronic devices. In some examples, an electronic object 140 may include sensor circuits 142 that capture relative sensor data 144 that provide operational conditions of the respective electronic object 140 over time. The server 160 may obtain the plurality of sensor data 144 from multiple sensor circuits 142 and extrapolate resource usage patterns, resource consumption, resource depletion rate, and other information about the electronic objects 140. The server 160 may use this information to analyze the current resource usage pattern for each electronic object 140 and predict or infer a time window in the future to allocate additional resources to each electronic object 140. For example, the server 160 may compare the historical resource consumption data with the current resource usage pattern for a given electronic object 140 and determine whether the given electronic object 140 requires additional resources to operate without interruptions. If the server 160 anticipates that an electronic object 140 requires additional resources in a time window in the future, the server 160 may generate a resource allocation scheme to allocate the additional resources to the object 140 within the tine window in the future. In some embodiments, the server 160 may execute the resource allocation scheme by, for example, physically allocating the additional resources to the electronic object 140 when within the anticipated time window. For example, if the electronic object 140 is a computing device that requires additional processing power or memory capacity, the server 160 may dynamically provision physical computing resources from a distributed cloud computing system in a server farm (e.g., virtual machines resources 132 from a recommended entity 130) to the computing device. In this manner, the disclosed system 100 enables the electronic devices to continue their operations as intended without interruptions caused by lack of resources—which would occur with the static resource allocation method of conventional systems.

In some embodiments, the system 100 may provide resource allocation recommendations for multiple objects 140a-n at a macro scale. For example, the server 160 may analyze aggregated resource consumption data across multiple objects 140a-n to identify broader resource allocation trends and inefficiencies in resource allocations or distributions. In response, the server 160 may generate a resource allocation and distribution scheme that improves resource usage and utilization across the interconnected objects 140a-n.

In some embodiments, the system 100 may balance resources across the objects 140a-n, such that no object 140 is undersupplied with resources while other objects 140 have excess or underutilized resources. For example, the system 100 may distribute the resources across the objects 140a-n such that no object 140 is undersupplied or has underutilized resources. This, in turn, leads to increasing resource utilization for all objects 140a-n.

In some embodiments, operations described with respect to electronic objects 140 may apply to non-electronic objects 140. For example, the system 100 may monitor and analyze resource consumption patterns for non-electronic objects 140, such as mechanical devices, household appliances, or consumable goods. The disclosed system 100 may extrapolate or infer a replacement schedule based on historical usage trends for a given object 140. In this manner, the disclosed system 100 provides practical applications for improving static conventional resource allocation techniques.

Further, the disclosed system 100 provides additional technical improvements over conventional resource allocation systems by implementing a dynamic, event-specific method for resource configuration (distribution and allocation) that proactively adapts to upcoming events. The current resource allocation systems that use static and fixed resource allocation at predefined intervals are not configured to consider upcoming fluctuations in resource needs of objects due to upcoming events (e.g., seasonal, regional, weather-based, or user-specific events). Thus, the conventional resource allocation systems suffer from reduced resource utilization and poor load balancing among objects.

The disclosed system 100 is configured to utilize external factors that affect resource needs for objects, such as weather data, news feed, user-specific data, and other type of data to extrapolate fluctuations in resource needs for an extended period of time in the future per object, per user, and/or per region. Thus, the disclosed system 100 is configured to extrapolate non-obvious correlations among the external factors that affect the future resource needs to derive meaningful insight from them and allocate (or reallocate) resources across objects to consider the upcoming resource needs. For example, the disclosed system 100 may analyze the weather data and/or news feed and extrapolate that there will be a snowstorm in a particular geographical location. The system 100 may also analyze historical resource allocation for particular object (e.g., computer components, tires of a vehicle, etc.) in that particular geographical location. In response, the system 100 may determine that the upcoming snowstorm may cause delays in transportation of the particular object from entities (e.g., suppliers) and therefore, shortage in the supply of a particular object and an increased demand for the particular object. In response, the system 100 may determine the correlation between the upcoming snowstorm with the resource demand for the particular object. Thus, the system 100 may predict a spike in resource needs for the object in the particular geographical location and generate an event-specific resource allocation recommendation to preemptively allocate additional resources for the object. The system 100 may derive the quantity of resources to be allocated for the object, a time frame to allocate the resources for the object, an entity that provides the object, among others. In response, the system 100 may execute the resource allocation command code that, upon execution, causes the determined resources to be allocated for the object within the prescribed time window.

In this manner, the system 100 is configured to consider external factors that affect the resource needs for objects and increase the resource allocation utilization across objects. This, in turn, reduces the distributions and downtime for objects that rely on resources to operate or be operated. In some examples, assuming that the objects include computer components for a data center, by implementing the system 100, the upcoming resource needs for the data center to operate without interruptions in its operations due to an event (e.g., seasonal, regional, weather-based, etc.) is extrapolated from the historical and current weather data, resource consumption pattern, news feed, among other types of data. In response, the system 100 may generate an event-specific resource configuration to preemptively anticipate the required quantity of computer components, future time window, and an entity that provides the computer components. The system 100 may execute the resource allocation command code that, upon execution, allocates the determined computer components to the data center within the prescribed time window. In this example, by proactively managing resource allocation, the system 100 improves the operational performance and stability of the data center, and reduces the disruptions caused by upcoming events. Further, the system 100 reduces latency in data center’s operations and overloads in operations of the data center. Further, the system 100 reduces component failure that would occur if additional resources were not provided to the data center and the current components of the data center are overburdened with excess computational tasks. Further, the system 100 improves the reliability of the data center by providing resources ahead of the time of the resource needs.

### System components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example user device

Each user device 120 (e.g., any of user devices 120a-n) may generally be any device that is configured to process data and interact with users. Examples of the user device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The user device 120 may include a user interface, such as a display, a microphone, a camera, a keypad, or other appropriate terminal equipment usable by users. The users 102a-n may use the user devices 120a-n to access the edge software application 134.

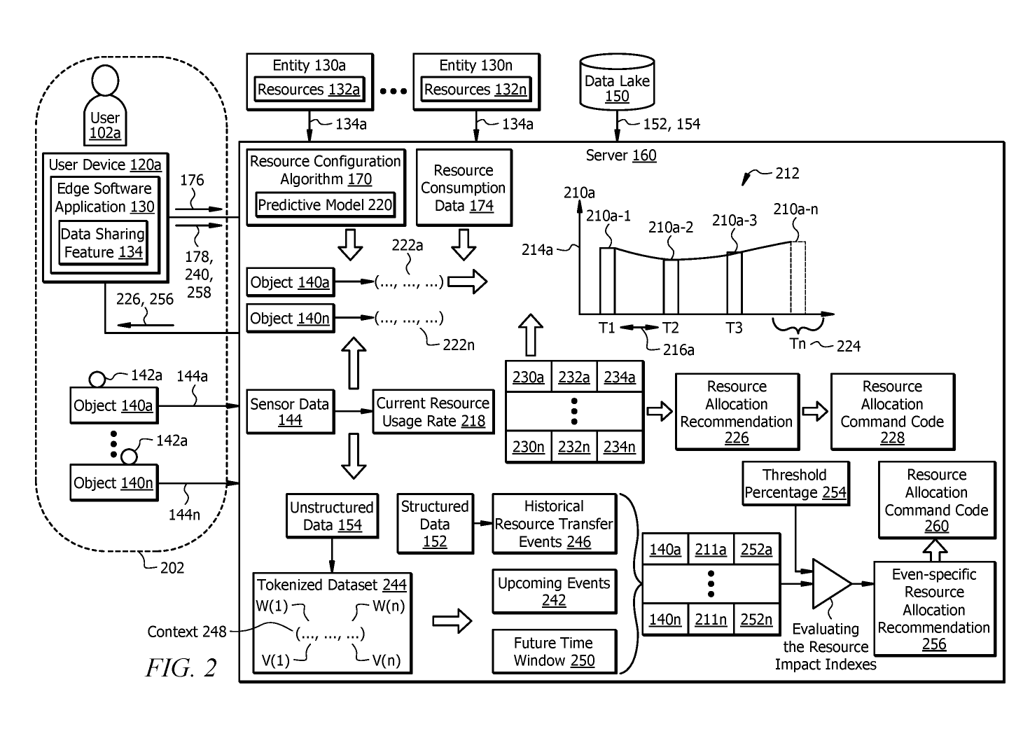

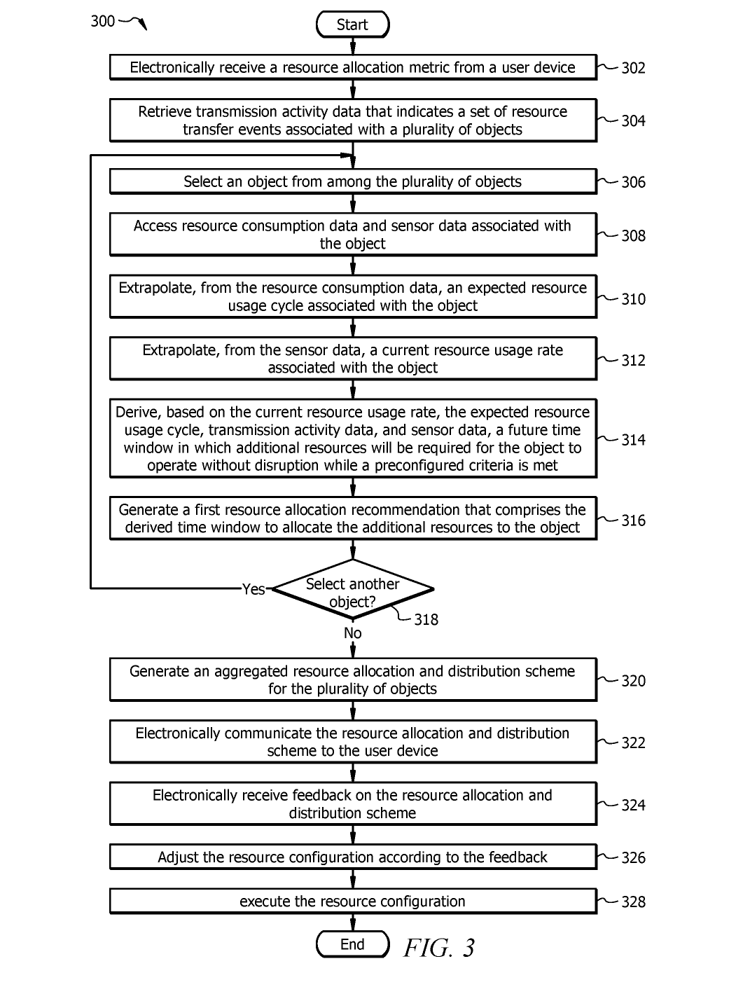

Each user device 120 includes a processor 122 in signal communication with a network interface 124 and a memory 128 configured to perform any of the functions or actions of the user device 120 described herein. The user device 120 is configured to communicate with other devices and components of the system 100 via the network 110. Processor 122 comprises one or more processors. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 122 may be a programmable logic device, a microcontroller, a microprocessor, or any suitable number and combination of the preceding. The one or more processors are configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations. The processor 122 may register the supply operands to the ALU and store the results of ALU operations. The processor 122 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 136) to perform the operations of the user device 120 described herein. In this way, processor 122 may be a special-purpose computer designed to implement the functions disclosed herein. In an embodiment, the processor 122 is implemented using logic units, FPGAs, ASICs, DSPs, or any other suitable hardware. The processor 122 is configured to operate as described in FIGS. 1-4. For example, the processor 122 may be configured to perform one or more operations of the operational flow 200 as described in FIG. 2, and one or more operations of the method 300 as described in FIG. 3.

Network interface 124 is configured to enable wired and/or wireless communications. The network interface 124 may be configured to communicate data between the user device 120 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol.

The user interface 126 may generally be peripherals that accept input from users. In some examples, the user interface 126 may include a keyboard, a mouse, a display screen, and buttons, among others. The user may input data to the user interface 126. For example, the user may input their desired thermal reading for the target space to the user interface 126. The display screen may generally be an electronic monitor or screen that is configured to present or display data, such as the software applications 134, and the like. Examples of display screens may include liquid crystal display (LCD), light emitting diode (LED), organic LED (OLED), and the like. In some examples, the display screen may be a touch screen display that is configured to accept input from users.

The memory 128 may be a non-transitory computer-readable medium. The memory 128 may be volatile or non-volatile and may comprise read-only memory (ROM), random-access memory (RAM), ternary content-addressable memory (TCAM), dynamic random-access memory (DRAM), and/or static random-access memory (SRAM). The memory 128 may include one or more of a local database, a cloud database, a network-attached storage (NAS), etc. The memory 128 comprises one or more disks, tape drives, or solid-state drives, and may be used as an over-flow data storage device, to store programs when such programs are selected for execution, and to store instructions and data that are read during program execution. The memory 128 may store any of the information described in FIGS. 1-4 along with any other data, instructions, logic, rules, or code operable to implement the function(s) described herein when executed by processor 122. For example, the memory 128 may store software instructions 136, edge software application 134, and/or any other data or instructions described herein. The software instructions 136 may comprise any suitable set of instructions, logic, rules, or code operable to execute the processor 122 and perform the functions described herein, such as some or all of those described in FIGS. 1-4.

The edge software application 134 may be a mobile, a web, or software application. The edge software application 134 may be configured to provide users 102a-n an interface to access their respective user profiles, and configure settings for data sharing with respect to one or more objects 140a-n, among other operations. The edge software application 134 may be associated with the server 160. For example, organization 112 to which the server 160 is associated, may provide the edge software application 134 to its users 102a-n to access their user profiles within the organization 112 and products and/or services provided by the organization 112. For example, a user 102a may access the edge software application 134 and select one or more objects 140a-n and opts-in to share resource-related data associated with the one or more objects 140a-n with the edge software application 134 and therefore the server 160.

In response, the resource-related data associated with the selected one or more objects 140a-n may be shared with the software application 134 and the server 160, for example, by the sensors 142a-n associated with those objects 140a-n communicating associated sensor data 144a-n to the user device 120a and/or the server 160. In some examples, the resource-related data associated with an object 140 may include operating status, operating conditions, resource consumption pattern, resource usage rate, among others with respect to that object 140.

In some examples, each object 140 may be associated with respective resources 210. In some examples, the resources 210 may include physical resources, such as physical devices (e.g., physical computers, mobile devices, transportation vehicles, and any component thereof), consumer electronics, physical objects, such as batteries, tires, household items, products, and goods, among others. In the same or other examples, resources 210 may include digital resources, such as computing resources (e.g., processing power, memory, and storage), network resources (e.g., network bandwidth, cloud services), and software resources (e.g., software application subscriptions), among others. In the same or other examples, the resources 210 may include virtual resources, such as digital assets (e.g., currencies, etc.)

### Example Entity

Each entity 130 (e.g., each of entities 130a-n) may be or include an organization that provide certain products and/or services to their users 102. For example, an entity 130 may provide products, such as appliances, consumer electronic devices, goods, and/or objects 140 to their users 102. In the same or another example, an entity 130 may provide services, such as software applications, and/or security services to their users 102. The user 102 may subscribe to an entity 130 to receive such products and/or services.

The entities 130a-n may utilize resources 132a-n, respectively to provide their products and/or services. In some examples, the resources 132a-n may include computing resources (e.g., processing power, memory, and storage), network resources (e.g., network bandwidth, cloud services), and software resources (e.g., software application subscriptions), among others. In the same or other examples, the resources 132a-n may include people or employees of an entity 130. In the same or other examples, the resources 132a-n may include physical resources, such as computer systems, office space, warehouses, equipment, and inventory of available physical products (e.g., some of the objects 140), among others. The entities 130a-n may provide resource data 134a-n to the server 160, respectively, where the resource data 134a-n may indicate the available or current resources 132 at the entity. The server 160 may use this information to anticipate which entity 130 is recommended to meet the resource need with respect to a given object 140 in future and include the recommended entity in the recommendation to users 102.

In some embodiments, the server 160 may provide information to entities 130 about upcoming resource needs for the objects 140a-b to consider upcoming fluctuations in the resource needs and adjust their resources 132 to be able to fulfill the anticipated demand for resources. For example, the server 160 may analyze historical resource consumption patterns across multiple objects 140a-n and predict future resource allocation and distribution needs based on resource usage trends, resource depletion rates, and expected operational demand across the objects 140a-n. In response, the server 160 may provide this information to entities 140a-n to proactively adjust their resource allocations (e.g., resources 132), and supply chain to be able to meet the predicted resource demands.

### Example Objects

In some examples, an object 140 (e.g., any of objects 140a-n) may include an electronic device, such as a computer system, a mobile device, a transportation vehicle, a household appliance, or any other device that is electrically powered. In some examples that an object 140 is an electronic device, the object 140 may include sensor circuits 142 that are configured to capture respective sensor data 144. The sensor circuits 142 of an electronic device may monitor the operational status and conditions of the electronic device. The sensor data 144 captured by a sensor circuit 142 of an electronic device may include operational parameters, such as a physical characteristic that affects the resource consumption of the electronic device.

In some embodiments, a sensor circuit 142 may include hardware sensor circuitry, sensing elements, electronic circuit boards that include capacitors, transistors, resistors, microprocessors, and other components arranged and configured to detect a respective sensor data 144. For example, if an object 140a is a transportation vehicle (e.g., autonomous or non-autonomous vehicle), the sensor circuits 142a may include tire pressure sensor circuits, battery status monitor circuits, fuel level sensor circuits, or engine diagnostics sensor circuits that generate sensor data 144a. In this example, the sensor data 144a may include tire pressure data, battery level data, and engine status sensor data, among others. In another example, if an object 140n is a house appliance, the sensor circuits 142n may include thermal sensor circuits, battery status monitoring sensor circuits, filter condition monitoring sensor circuits, etc. In this example, the sensor data 144n may include thermal data, battery status data, and filter condition data, among others. If the user 102 has opted-in to share resource-related data for an object 140 on edge software application 134, the server 160 may receive and analyze the sensor data 144 associated with the object 140. The server 160 may correlate the received data with historical usage patterns and determine whether the object 140 requires additional resources, maintenance, or an adjustment in operational settings.

In some examples, an object 140 (e.g., any of objects 140a-n) may be a non-electronic device, such as consumable products, mechanical components, etc. In such examples, the consumption and usage pattern of the object may be determined based on the acquisition history of the object.

In some embodiments, one or more sensor circuits 142 may be implemented to track the inventory of objects 140 (e.g., electronic and/or non-electronic objects). For example, a weight sensor circuit 142 may be implemented in a place where some objects 140 are maintained (e.g., weight sensor circuits 142 in a refrigerator to track a number of each type of food). When the sensor data 144 indicates that the weight in a dedicated portion where a particular type of food is stored is less than a predefined threshold, the server 160 may generate a resource allocation recommendation and notify the user 102 through the edge software application 134 to the particular type of food needs to be replenished, e.g., from a particular entity 130a that provides the particular type of food.

### Example data lake

The data lake 150 generally include a physical storage infrastructure and is configured to store and maintain structured data 152 and unstructured data 154. Examples of the data lake 150 include, but are not limited to, a distributed file system, a cloud-based object storage system, a relational database management system (RDBMS), a non-relational data store, or any combination thereof. In some embodiments, the data lake 150 may store the structure data 152 and the unstructured data in a time series format, relational, non-relational, among other data formats. the data stored in data lake 150 is enriched with relative timestamps. This allows retrieval and analysis of the specific data over a specific time range. In some embodiments, the structured data 152 may include historical resource transfer events associated each object 140a-n, information about resources 132a-n received from the entities 130a-n, structured weather data, sensor data 142a-n, among others. The historical resource transfer events associated with each object 140 may indicate the quantity of physical and/or digital resources consumed with respect to the associated object 140 over time. The information about resources 132a-n may include current and historical resources 132a-n, services and/or products provided to user 102a-n, etc. The structured weather data may be in a particular data structure, such as JavaScript Object Notation (JSON), or other data formats.

In some embodiments, the unstructured data 154 may include new reports (e.g. live news feed, regional news feed, seasonal news feed), unstructured weather data, among others. The news reports may include free-form text description that indicates an event with respect to one or more geographical locations. The unstructured weather data may be presented in an unstructured format, e.g., in form of a satellite image, radar scan, etc. The unstructured weather data may include text, bits, symbols, numbers, pixels, images that indicates weather condition in one or more geographical locations. Other components of the system 100 may periodically (e.g., every minute, every day, etc.) communicate relative data to the data lake 150. For example, the entities 130a-n may communicate the resource data 134a-n to the data lake 150, respectively, and the sensor circuits 142a-n may communicate the sensor data 144a-n to the data lake 150, respectively. The data lake 150 may provide this information to the server 160 for further processing.

### Example server

The server 160 generally includes a hardware computer system. In certain embodiments, the server 160 may be implemented by a cluster of computing devices, such as virtual machines. For example, the server 160 may be implemented by a plurality of computing devices using distributed computing and/or cloud computing systems in a network. In certain embodiments, the server 160 may be configured to provide services and resources (e.g., data and/or hardware resources as described herein, etc.) to other components and devices.

The server 160 may comprise a processor 162 operably coupled with a network interface 164 and a memory 166. The processor 162 comprises one or more processors. The processor 162 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The processor 162 may be a programmable logic device, a microcontroller, a microprocessor, or any suitable number and combination of the preceding. The one or more processors are configured to process data and may be implemented in hardware or software. For example, the processor 162 may be 8-bit, 16-bit, 32-bit, 64-bit, or of any other suitable architecture. The processor 162 may include an ALU for performing arithmetic and logic operations. The processor 162 may register the supply operands to the ALU and store the results of ALU operations. The processor 162 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 168) to perform the operations of the server 160 described herein. In this way, the processor 162 may be a special-purpose computer designed to implement the functions disclosed herein. In an embodiment, the processor 162 is implemented using logic units, FPGAs, ASICs, DSPs, or any other suitable hardware. The processor 162 is configured to operate as described in FIGS. 1-4. For example, the processor 162 may be configured to perform one or more operations of the operational flow 200 as described in FIG. 2, and one or more operations of the method 300 as described in FIG. 3.

The network interface 164 is configured to enable wired and/or wireless communications. The network interface 164 may be configured to communicate data between the server 160 and other devices, systems, or domains. For example, the network interface 164 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 162 may be configured to send and receive data using the network interface 164. The network interface 164 may be configured to use any suitable type of communication protocol.

The memory 166 may be a non-transitory computer-readable medium. The memory 166 may be volatile or non-volatile and may comprise read-only memory (ROM), random-access memory (RAM), ternary content-addressable memory (TCAM), dynamic random-access memory (DRAM), and/or static random-access memory (SRAM). The memory 166 may include one or more of a local database, a cloud database, a network-attached storage (NAS), etc. The memory 166 comprises one or more disks, tape drives, or solid-state drives, and may be used as an overflow data storage device, to store programs when such programs are selected for execution, and to store instructions and data that are read during program execution. The memory 166 may store any of the information described in FIGS. 1-4 along with any other data, instructions, logic, rules, or code operable to implement the function(s) described herein when executed by processor 162. For example, the memory 166 may store software instructions 168, resource configuration algorithm 170, training dataset 172, resource allocation metrics 176, resource consumption data 174, sensor data 144a-n, resources 210, transmission activity data 178, the event-specific resource configuration algorithm 180, training dataset 182, resource allocation recommendations 266, event-specific resource allocation recommendations 256, resource allocation command code 228, 260, and/or any other data or instructions. The software instructions 168 may comprise any suitable set of instructions, logic, rules, or code operable to execute operations of the processor 162 and perform the functions described herein, such as some or all of those described in FIGS. 1-4.

The resource configuration algorithm 170 may be implemented by the processor 162 executing the software instructions 168 and is generally configured to dynamically monitor, evaluate, extrapolate, and allocate physical and/or digital resources across objects 140a-n within the system 100 as needed according to the resource allocation metrics 176 and resource usage patterns. In some embodiments, the resource configuration algorithm 170 comprises multiple computational models, including rule-based logic, machine learning models, artificial intelligence models, Large Language Models (LLMs), Small Language Models (SLMs), etc. In some embodiments, the resource configuration algorithm 170 may comprise a support vector machine, neural networks, random forest, k-means clustering, etc. The resource configuration algorithm 170 may be implemented by a plurality of neural network layers, convolutional neural network (CNN) layers, Long-Short-Term-Memory (LSTM) layers, Bi-directional LSTM layers, recurrent neural network layers, and the like. In some embodiments, the resource configuration algorithm 170 may implement a natural language processing machine learning algorithm, text processing machine learning algorithm, among others.

In some embodiments, the resource configuration algorithm 170 may be implemented by a supervised machine learning technique. For example the resource configuration algorithm 170 may be trained on a training dataset 172 that includes multiple samples of historical resource consumption patterns by respective objects140a-b, historical sensor data 144a-n from associated sensor circuits 142-an, each annotated or labeled with a respective resource allocation, distribution, and replenishment recommendation that is confirmed by a user.

During the training phase, the resource configuration algorithm 170 may extract a set of features from each training data sample by feeding the training data sample to the neural networks. The neural networks of the resource configuration algorithm 170 may process the input and capture the relationship between the features of the input data. The output of the neural network may include an embedding vector that comprises numerical values that represent the extracted features in a vector space. For example, the features may include resource consumption patterns, resource usage trends, resource utilization, correlations between sensor data 144 and associated resource consumption patterns and resource allocation recommendations, among others. The resource configuration algorithm 170 transforms each training data sample into a respective embedding vector through its neural networks, such as convolutional layers (for spatial-temporal feature extraction), recurrent layers (for sequence modeling), and attention layers (for contextual relevance weighting).

The resource configuration algorithm 170 may perform similar operations on each training data sample and generate multiple embedding vectors in the vector space. The embedding vectors represent resource consumption patterns across different objects 140a-n and associated resource allocation recommendations, respectively. The resource configuration algorithm 170 may learn to associate each training data sample with its label through reinforcement learning. The resource configuration algorithm 170 may adjust the weight and bias values of its neural networks through a backpropagation process to increase its prediction of resource allocation recommendation for a given input dataset of resource consumption and sensor data.

During the testing phase, the resource configuration algorithm 170 is given an unlabeled, unseen dataset that comprises a resource usage pattern and sensor data associated with one or more objects 140a-n, and is asked to extrapolate or generate a resource allocation scheme for the provided dataset such that it would increase the resource utilization and distribution, and reduces the resource depletion across the one or more objects 140a-n.

The resource configuration algorithm 170 may extract a set of features from the testing dataset by feeding the testing dataset to its learned neural network whose weight and bias values are configured to detect the pattern in the resource consumption, deviations between the current resource usage pattern and the expected usage pattern (from the training dataset 172), correlations between the sensor data and the current resource usage pattern, and generate a resource allocation scheme. The resource configuration algorithm 170 may generate an embedding vector to represent the testing dataset in the vector space.

The resource configuration algorithm 170 may compare the generated embedding vector with each embedding vector from the training stage, e.g., by determining a distance (such as Euclidean distance or cosine similarity) between the generated embedding vector and each embedding vector from the training stage. In response, the resource configuration algorithm 170 may determine the closest matching or corresponding embedding vector to the generated embedding vector. The resource configuration algorithm 170 may extrapolate a resource allocation scheme that balances resource distribution, resource allocation, and resource depletion across the objects 140a-n based on the intelligence learned from the training phase. The generated recommendation may further be based on resource availability at entities 130 and resource allocation metrics 176 set by the user 102. For any resource configuration (e.g., allocation and distribution), the resource configuration algorithm 170 may take the resource allocation metric 176 into consideration to generate the recommended configuration that meets the preconfigured criteria set by the resource allocation metric 176.

The event-specific resource configuration algorithm 180 may be implemented by the processor 162 executing the software instructions 168 and is generally configured to dynamically detect an upcoming event 242 and upcoming resource needs for an object 140, and in response, generate an event-specific resource allocation recommendation that considers the upcoming resource needs for the object 140.

In some embodiments, the event-specific resource configuration algorithm 180 comprises multiple computational models, including rule-based logic, machine learning models, artificial intelligence models, Large Language Models (LLMs), Small Language Models (SLMs), etc. In some embodiments, the event-specific resource configuration algorithm 180 may comprise a support vector machine, neural networks, random forest, k-means clustering, etc. event-specific resource configuration algorithm 180 may be implemented by a plurality of neural network layers, CNN layers, LSTM layers, Bi-directional LSTM layers, recurrent neural network layers, and the like. In some embodiments, the event-specific resource configuration algorithm 180 may implement a natural language processing machine learning algorithm, text processing machine learning algorithm, among others. In some embodiments, the event-specific resource configuration algorithm 180 may operate similar to the resource configuration algorithm 170, and in addition, provide a resource configuration scheme that is tailored to and specific for an upcoming event. The event-specific resource configuration algorithm 170 may be trained by the training dataset 182 that includes a set of historical event-driven resource consumption patterns, external event data (e.g., weather fluctuations, seasonal resource demand fluctuations, supply chain disruptions), and associated resource allocation responses. Each training sample in the training dataset 182 may be annotated with an event type, its impact on resource demand for one or more objects 140, and a corresponding resource allocation recommendation that was validated based on past user feedback.

During the training phase, the event-specific resource configuration algorithm 180 extracts features from each training data sample to identify patterns that correlate each specific event with fluctuations in resource consumption per object 140. The event-specific resource configuration algorithm 180 learns the patterns and associations between each training data sample and its labels (e.g., the type of event 242). The weight and bias values of the neural network of the event-specific resource configuration algorithm 180 are updated through backpropagations to increase the accuracy of extrapolation of resource configurations per object 140 for a given event 242.

During the testing phase, the event-specific resource configuration algorithm 180 receives unlabeled event data, including detected upcoming events, and historical and current (e.g., real time) resource consumption patterns for one or more objects 140 over a period of time. The event-specific resource configuration algorithm 180 extracts features from the testing data using its trained neural networks, compares the extracted features against the learned embedding space from the training phase, and determines the closest corresponding historical event. In response, the event-specific resource configuration algorithm 180 generates an event-specific resource allocation scheme that considers the current resource availability at entities 130 and the predefined resource allocation metrics 176, as well as the learned correlations between the events and associated resource allocation and recommendation during the training phase.

### Operational flow for resource configuration across objects

FIG. 2 illustrates an example of operational flow 200 of system 100 (see FIG. 1) for resource configuration across objects 140a-n according to some embodiments. In operation, the operational flow 200 may begin when user 102a opts-in on the edge software application 134 to enable a data sharing feature 138 with the server 160 that is associated with the organization 112.

The data sharing feature 138 may enable inter-process communication among the user device 120a, objects 140a-n, sensor circuits 142a-n, and server 160. For example, the user 102a may log into their user profile on the edge software application 134 and enable the data sharing feature 138. In doing so, the user 102a may indicate which of the objects 140a-n is/are to be integrated into the formation of the network of interconnected devices (e.g., user device 120a, objects 140a-n, sensor circuits 142a-n, and server 160). In response, the user device 120a and/or the server 160 may establish a wireless communication channel with the selected objects 140a-n to be able to receive associated resource-related data, such as sensor data 144a-n.

The user 102a may further indicate resource allocation metrics 176 on the edge software application 134. The resource allocation metrics 176 may indicate user-defined preferences, constraints, and prioritization of resource allocation and distribution across the objects 140a-n (e.g., electronic and/or non-electronic objects) while meeting the predefined criteria. In some examples, the user 102a may define the criteria, such as operational goals with respect to the objects 140a-n, and a range of resources to be allocated, among others.

Upon enabling the data sharing feature 138, the resource consumption data 174 may be shared with the server 160. The resource consumption data 174 may indicate historical records of physical and/or digital resource consumption by each object 140 over a period of time (e.g., over a year, two years, ten years, etc.). For example, the resource consumption data 174 may include a set of time-series records of resource consumption by or with respect to each object 140 over a period of time.

In some embodiments, in response to the data sharing feature 138 being enabled on the edge software application 134, the user device 120a may communicate the resource allocation metric 176 and historical resource consumption data 174 to the server 160. In some embodiments, in response to the data sharing feature 138 being enabled on the edge software application 134, the server 160 may automatically retrieve the resource allocation metric 176 and historical resource consumption data 174 from a device that they are maintained and stored, such as the user device 120a or a network-attached database (not explicitly shown) where they are stored.

In response to the data sharing feature 138 being enabled on the edge software application 134, the server 160 may automatically receive the sensor data 144a-n from the sensor circuits 142a-n, respectively. In some embodiments, one or more sensor circuits 142a-n may initiate communicating their respective sensor data 144a-n to the server 160 and/or user device 120a within and outside the geofence 202 periodically (e.g., every second, every minute, every day, etc.) or on demand based on a network request from the user device 120a and/or server 160. In some embodiments, one or more sensor circuits 142a-n may initiate transmission of their respective sensor data 144a-n to the server 160 and/or user device 120a upon determining that they are located within a predefined geofence 202. The geofence 202 may be configured to define a virtual boundary corresponding to a designated physical area, such as a residential address associated with the user 102a, a specified distance from the user device 120a, a boundary surrounding a central router or modem, or a defined radius from one or more of the server 160 and/or user devices 120a. The geofence 202 may be centered around a fixed or dynamic geographic coordinate or a specific network boundary, such as a wireless communication range from user device 120a, server 160, a central router, modem device (e.g., to which the user device 120a and/or server 160 is wirelessly connected or provided by). For example, when the geofence 202 is defined by the wireless communication range from the user device 120a, when the sensor circuits 142a-n detect that they are within the communication range of the user device 120a—such as by establishing a Bluetooth, Wi-Fi, or other wireless connection—the sensor circuits 142a-n may automatically initiate transmission of their respective sensor data 144a-n to the user device 120a and/or to the server 160 e.g., via the network 110 and/or user device 120a. The geofence 202 may be established using geographic coordinates, global positioning system (GPS) location detection, network signal ranges (e.g., Wi-Fi, Bluetooth), or other location-based technologies. When the sensor circuits 142a-n detect that they are within the boundary defined by the geofence 202, they may automatically activate their data transmission protocols and communicate the sensor data 144a-n to the server 160 and/or user device 120a. In some embodiments, in response to electronically receiving the resource allocation metrics 176, e.g., from the user device 120a, the server 160 may automatically retrieve the transmission activity data 178 from the user device 120a via the network. The transmission activity data 178 may indicate a set of resource transfer events associated with the objects 140a-n. In some examples, the resource transfer events may include interaction history associated with the objects 140a-n, physical resource transfer events (e.g., physical components of an object 140), digital resource transfer events (e.g., processing, memory, network resources), among others, similar to that described in FIG. 1.

The server 160 may automatically retrieve resource data 134a-n from the entities 130a-n periodically (e.g., every second, every minute, every day, etc.) or on demand based on a network request from the server 160. The server 160 may use this information to determine the availability and distribution of physical and digital resources 210 across different entities 130a-n and determine which entity 130 is to be recommended to provide a given object 140 and/or resources 132 for a given object 140 at a given time. The server 160 may consider this information when generating resource allocation recommendations to users 102a-n for a given object 140, such as which entity 130 is recommended to provide a given object 140 and/or resources 132 for a given object 140 at a given time in future.

### Extrapolating an expected resource usage cycle

The server 160 (e.g., via the resource configuration algorithm 170) may extrapolate an expected resource usage cycle 212 for each object 140 from the resource consumption data 174, historical transmission activity data 178, and/or sensor data 144. The expected resource usage cycle 212 associated with each object 140 may indicate a recurring pattern of resource usage by the respective object 140 at every predefined interval. In this process, the resource configuration algorithm 170 may analyze the resource consumption data 174 to identify recurring trends in resource usage over time for each object 140. For example, the resource configuration algorithm 170 may detect periodic resource consumption patterns, such as a vehicle requiring new tires approximately every six months, a computing device requiring additional physical computing resources (e.g., physical every two weeks) to perform certain computational tasks, etc.

The resource configuration algorithm 170 may correlate the historical transmission activity data 178 with the resource consumption data 174 to refine the expected resource usage cycle 212. For example, if previous transmission activity data for a vehicle that new tires were inquired every six months, this may be additional information that confirms the expected resource usage cycle.

The resource configuration algorithm 170 may correlate the sensor data 144 with the resource consumption data 174 to further refine the expected resource usage cycle 212. Continuing the example of a vehicle, the sensor circuits 142 may provide real-time operational data—such as tire pressure data, mileage traveled by the vehicle, etc. The resource configuration algorithm 170 may use this information to correlate the sensor data with the historical and current resource consumption data 174 to adjust the expected resource usage cycle 212 for the vehicle.

For example, as shown in FIG. 2, with respect to object 140a, the resource configuration algorithm 170 may generate a set of data points on a plot 214a where the x-axis is time and the y-axis indicates the amount of resources 210a. The resource configuration algorithm 170 may extrapolate that the object 140a was allocated with the amount of resources 210a-1 at time t(1), the object 140a was allocated with the amount of resources 210a-2 at time t(2), object 140a was allocated with the amount of resources 210a-3 at time t(3). The resource configuration algorithm 170, via linear regression techniques or non-linear regression techniques, may generate a trend or pattern line that connects these sample data points.

Based on this information, the resource configuration algorithm 170 may extrapolate or infer the expected resource usage cycle 212 for the object 140a at every interval 216a (e.g., average of each sample data points) and the associated quantities of resources 210a-1 through 210a-n at those timestamps. The server 160 may perform similar operations for other objects 140a-n to extrapolate their respective expected resource usage cycles 212.

In some embodiments, the server 160 may extrapolate the expected/predicted resource usage cycle 212 and expected/ predicted quantity of resources 210a-n at future time window t(n) based on the pattern of previous data points as shown in the plot 214a. To this end, the server 160 may generate a predictive model 220 that is configured to analyze the historical resource consumption patterns, transmission activity data 178, and sensor data 144 to predict future resource demands for each object 140. For example, the server 160 (e.g., via the resource configuration algorithm 170) may generate embedding vectors 222a-n for each object 140a-n, respectively, where each embedding vector 222 may include numerical values that represent extracted features of the respective resource usage and consumption pattern over time.

The server 160 (e.g., via the resource configuration algorithm 170) may extract relevant features from the resource consumption data 174, historical transmission activity data 178, and sensor data 144, such as frequency (e.g., interval 216) and quantity of resources 210 allocated to each object 140, time of historical resource allocations, operational conditions extracted from the sensor data 144, among others.

The server 160 (e.g., via the resource configuration algorithm 170) may determine the classification or clusters of the generated embedding vectors 2220a-n in the vector space, where the objects 140 with similar resource consumption patterns may form a dense area of embedding vectors 222. The resource configuration algorithm 170 may be trained using the training dataset 172 and/or the past resource allocation patterns to predict future resource allocation needs (e.g., time window, and the quantity/number and type of resources 210) for a given object 140. The predictive model 220 may be the inference model of the resource configuration algorithm 170 that is trained to predict or infer upcoming resource allocation needs for a given object 140 based on the historical resource consumption, usage, allocation, and distribution pattern.

After the training phase, the server 160 (e.g., via the predictive model 220) may generate an expected resource usage cycle 212 for each object 140. In some embodiments, the server 160 may extrapolate, from the sensor data 144, the current resource usage rate 218 for each object 140, where the current resource usage rate 218 may indicate the rate of depletion in resource usage by the associated object 140. The server 160 (e.g., via the predictive model 220) may consider the current resource usage rate 218 when extrapolating the future resource allocation needs and time window for a given object 140. For example, if the sensor data 144 indicates that a vehicle’s tire pressure is depleting at a faster rate than previously observed, the predictive model 220 may adjust the expected resource usage cycle 212 accordingly.

With respect to the object 140a, as shown in FIG. 1, the server 160 (e.g., via the predictive model 220) may derive a future time window t(n) in which the additional resources 210a-nwill be required for the object 140a to operate without disruption while the criteria indicated by the resource allocation metrics 176 is met. The server 160 (e.g., via the predictive model 220) may perform similar operations for other objects 140 to derive future time windows for other objects 140 according to their respective resource-related data.

### Generating a resource allocation recommendation

In the example of object 140a as shown in FIG. 2, in response to deriving the future time window t(n) indicated by time window 224 and determining the expected quantity of resources 210a-n the server 160 (e.g., via the predictive model 220) may generate a first resource allocation recommendation 226a that comprises the derived future time window 224 to allocate the additional resources 210a-n to the object 140a. In this process, the predictive model 220 may execute a plurality of simulation operations 230a-n for various resource allocation schemes 232a-n across multiple objects 140 to determine a more efficient resource allocation scheme that would meet the resource needs of the objects 140 as well as the criteria indicated in the resource allocation metrics 176. For example, each simulation operation 230 (e.g., any of the simulations operations 230a-n) may include evaluating a distinct resource allocation scheme 232, where the resource configuration algorithm 170 iteratively adjusts allocation parameters, resource distribution, and resource allocation scheduling to the objects 140 to meet resource allocation needs based on predefined criteria.

In some embodiments, during each simulation operation 230, the resource configuration algorithm 170 may iteratively adjust a set of resource allocation parameters, including an allocation weight for each object 140, based on the prioritization of resource allocation according to a resource allocation metric 176 until the predefined criteria is met. In some embodiments, during each simulation, the resource configuration algorithm 170 may iteratively adjust a distribution of resources 210 among the objects 140, e.g., by dynamically allocating and/or reallocating the resources 210 based on the historical resource needs and sensor data 144. In some embodiments, during each simulation operation 230, the resource configuration algorithm 170 may iteratively adjust a schedule of the resource allocation among the objects 140.

The resource allocation algorithm 170 may determine a performance index 234a-n of the simulation operations 230a-n, respectively, where the performance index 234 of a given simulation operation 230 may indicate the efficiency of resource utilization across the objects 140 while meeting the predefined criteria. For example, if a resource allocation scheme 232 in a simulation operation 230 leads to 90% of the objects 140 receiving their resources and the predefined criteria is met, the performance index 234 associated with that simulation operation 230 may be higher compared to other simulations where less objects 140 received their allocated resources within the predefined criteria. In another example, if the predefined criteria is not met as a result of a resource allocation scheme 232, the performance index 234 of the associated simulation may be reduced proportionally.

The resource allocation algorithm 170 may rank the performance indexes 234a-n and determine a resource allocation scheme 232 that is associated with the highest performance index 234 compared to other resource allocation schemes 232. In response, the resource allocation algorithm 170 may generate the resource allocation recommendation 226 according to the resource allocation scheme 232 that is associated with the highest performance index 234. The generated resource allocation recommendation 226 may include the respective quantity of resources to be allocated to each object 140. The generated resource allocation recommendation 226 may include a recommended entity 130 that provides the additional resources. In some embodiments. The server 160 (e.g., via the resource allocation algorithm 170) may dynamically update the resource allocation recommendation 226 based on fluctuations in resource availability with respect to the entities 130, fluctuations in resource needs based on sensor data 144, transmission activity data, among other data. The resource allocation recommendation 226 may be an aggregated resource allocation recommendation 226 that includes resource configuration for multiple objects 140a-n, such as resource allocation, resource quantity, resource type, time window for a respective object 140, and associated entity 130 that provides the respective resource for the objects 140.

In response to generating the resource allocation recommendation 226, the server 160 may electronically communicate the resource allocation recommendation 226 to the user device 120a, via the network, e.g., in a network packet as a message. For example, the resource allocation recommendation 226 may include a list of recommended resource allocations for one or more objects 140, the expected time windows 224 for allocation and the corresponding quantity of resources 210 for each object 140, the recommended entity 130, and/or any other information. The resource allocation recommendation 226 may be accessible from the edge software application 134. The user 102a may accept, edit, or reject one or more of the resource allocations. This feedback may be communicated to the server 160 in the electronic message 240. The server 160 may electronically receive the electronic message 240 that indicates the feedback on the resource allocation recommendation 226. In response, the server 160 (e.g., via the resource configuration algorithm 170) may adjust the resource configurations (e.g., resource allocations, resource distributions, resource allocation schedules, the quantity of resources, the entity) by reconfiguring one or more aspects of the initial resource configurations according to the feedback on the resource allocation recommendation 226.

In some embodiments, the server 160 may execute the aggregated resource allocations indicated in the recommendations 226 by, for example, generating and executing the resource allocation command code 228. The resource allocation command code 228 may include code that upon execution by a processor 162 or 122, causes the processor to allocate the respective resources 210 to the respective object 140 when within the anticipated time window 224 for that object 140. In other words, when the resource allocation command code 228 is executed by the processor, the respective additional resources 210 are physically allocated to the respective object 140 when within the anticipated time window 224 for that object 140.

For example, adjusting the first resource allocation recommendation 226 comprises extrapolating, from the feedback that a first set of resources 210 should be allocated to the first object 140a, in response to extrapolating, from feedback, that the first set of resources 210 is to be allocated to the first object 140a, generating a resource allocation command code 228 that, upon execution by a processor, causes the processor to provision the first set of resources 210 to the first object, and executing the resource allocation command code 228. For example, if the object 140 is a computing device that is determined to be allocated with additional processing power or memory at the anticipated time window 224 from the recommended entity 130, the server 160 may provision virtual machine resources 132 from the recommended entity 130 to the computing device. The server 160 learns from the feedback from multiple resource allocation scenarios and update the weight and bias values of the neural network of the resource configuration algorithm 170 accordingly to increase the accuracy of future recommendations.

### Generating an event-specific resource configuration for an object

In some embodiments, the server 160 may provide resource configuration schemes for one or more objects 140a-n in response to an upcoming event 242 that affect upcoming resource needs for one or more objects 140a-n, resource supply for one or more objects 140, among others. In some examples, the upcoming events 242 may include seasonal events (e.g., a holiday season), regional events (e.g., weather-based event in one or more particular regions), user-specific event (e.g., life-event, such as starting a family), object-specific events (supply chain or inventory-related event for an object 140), and the like. The server 160 may execute the event-specific resource configuration algorithm 180 to provide a resource recommendation in response to an upcoming event 242. In this process, the server 160 may electronically retrieve, via the network, the set of structured data 152 and unstructured data 154, from the data lake 150. For example, the server 160 may receive a set of historical resource transfer events with respect to one or more objects 140.

The server 160 (e.g., via the event-specific resource configuration algorithm 180) may extract, from the structured data 152, the set of historical resource transfer events 246 with respect to one or more objects 140. In this process, the server 160 (e.g., via the event-specific resource configuration algorithm 180) may parse the structured data 152 to identify timestamps and associated resource transfer details for each recorded event associated with one or more objects 140. For example, the server 160 (e.g., via the event-specific resource configuration algorithm 180) may query (e.g., via structured query language (SQL) network request, time-series database queries) the data lake 150 for recorded events in a specific time range, such as from a first calendar date to a second calendar date for one or more objects 140.

When the relevant historical resource transfer events 246 are retrieved, the server 160 (e.g., via the event-specific resource configuration algorithm 180) may identify an interval between each pair of resource transfer events within the set of historical resource transfer events by determining the difference between the timestamps of successive resource transfer records. Further, the server 160 (e.g., via the event-specific resource configuration algorithm 180) may determine recurring trends in resource transfer events based on using pattern recognitions, Fourier transforms, and the like. The server 160 (e.g., via the event-specific resource configuration algorithm 180) may extract a quantity of resources in each historical resource transfer event within the set of historical resource transfer events and extrapolate a trend in resource transfer based on the identified interval between each pair of resource transfer events and the extracted quantity of resources in each historical resource transfer event.

The server 160 (e.g., event-specific resource configuration algorithm 180) may further extract, from the unstructured data 154, an upcoming event 242. In this process, the server 160 (e.g., event-specific resource configuration algorithm 180) may implement a natural language processing technique to normalize the text, such as by lowercasing all letters, etc. The server 160 (e.g., event-specific resource configuration algorithm 180) may implement word tokenization, sentence tokenization, sentence tokenization, sentence segmentation, etc. to split the text in smaller portions, such as into individual words.

The server 160 (e.g., event-specific resource configuration algorithm 180) may convert the text within the unstructured data 154 into a tokenized dataset 244 that includes a set of tokenized words (e.g., w(1) to w(n), where each w indicates a word) from the text. Each word within the text is converted into a respective numerical representation that indicates a literal meaning of the word, a semantic meaning of the word, positional relationship between the word and other words within the text, etc. For example, the first word w(1) is converted into a first vector v(1) and the nth word w(n) is converted into an n-th vector v(n).

The server 160 (e.g., event-specific resource configuration algorithm 180) may extract the context 248 of the text based on the tokenized dataset 244, e.g., by applying sequence modeling techniques, such as BiLSTM, to analyze word dependencies and infer the overall meaning of the text. Based on this information, the server 160 (e.g., event-specific resource configuration algorithm 180) may identify or references to future events 242 within the text.

The server 160 (e.g., event-specific resource configuration algorithm 180) may apply an entity recognition method that detects temporal expressions (e.g., dates, timeframes, such as mm, dd, yyyy, where mm is the month, dd is the day, and yyyy is the year) and event keywords (e.g., “storm,” “shortage,” “holiday”) within the processed text. In response, the server 160 may extrapolate a reference to the upcoming event 242 that is predicted to occur within a future time window 250. In response to extrapolating the historical resource transfer events 246, context 248 of the text, the upcoming event 242, and future time window 250, the server 160 (e.g., event-specific resource configuration algorithm 180) may extrapolate the correlation that indicates the upcoming event 242 will impact an upcoming resource transfer of a given object 140 (e.g., the first object 140a). For example, the server 160 (e.g., event-specific resource configuration algorithm 180) may determine the correlation between the identified event 242 and the historical resource consumption trends for a given object 140, determine which objects 140 were affected in response to similar past events, and determine how resource demands fluctuated in response to similar past events for a given object 140. Based on this information, the server 160 (e.g., event-specific resource configuration algorithm 180) may determine how the resource demand and supply of each object 140 will be impacted by the upcoming event 242, and how the resource demands of each object 140 will fluctuate.

### Deriving a resource impact index

The server 160 (e.g., event-specific resource configuration algorithm 180) may derive, based on the extrapolated correlations, a resource impact index 252 that indicates a percentage of each object 140 requiring a set of resources 211 due to the upcoming event 242. For example, with respect to the first object 140a the server 160 (e.g., event-specific resource configuration algorithm 180) may derive a first resource impact index 252a that indicates a percentage of the first object 140a requiring a first set of resources 211 due to the upcoming event 242, and a second resource impact index 252n that indicates a percentage of the second object 140n requiring a second set of resources 211n due to the upcoming event 242. The resources 211 may be examples of the resources 210 described above. Each resource impact index 252 for an object 140 may further indicate the probability of the upcoming event 242 affecting the respective object 140, such as resource demand needs, resource supply, etc.

The server 160 (e.g., event-specific resource configuration algorithm 180) may determine which resource impact index 252 is more than a threshold percentage 254 (e.g., more than 80%, 90%, etc.). For example, assume that the server 160 (e.g., event-specific resource configuration algorithm 180) determines that the resource impact index 252a of the first object 140a is more than the threshold percentage 254.

In response, the server 160 (e.g., event-specific resource configuration algorithm 180) may generate a first even-specific resource allocation recommendation 256 for the first object 140a. The first event-specific resource allocation recommendation 256 may include the quantity of the set of resources 211 to be allocated to the first object 140a, the future time window 250 in which the resources 211 is to be allocated to the first object 140a, the prescribed entity 130 that provides the set of resources 211 for the first object 140a, and any other resource configurations for other objects 140.

The server 160 may electronically communicate the first event-specific source allocation recommendation 256 to the user device 120a, via the network e.g., in a network packet as a message. The user 102a may view the first event-specific source allocation recommendation 256 on the edge software application 134 and accept, edit, or reject one or more aspects of first event-specific source allocation recommendation 256. The feedback may be communicated to the server 160 in the electronic message 258. The server 160 may electronically receive the electronic message 258 which includes the feedback on the first event-specific source allocation recommendation 256.

In response, the server 160 (e.g., event-specific resource configuration algorithm 180) may adjust the first event-specific resource allocation recommendation 256 according to the feedback. In this process, the server 160 (e.g., event-specific resource configuration algorithm 180) may extrapolate, from the feedback, what aspects of the recommendation 256 should be updated. For example, if the feedback indicates that a second set of resources 211 should be allocated to the first object 140a, adjusting the first event-specific resource allocation recommendation 256 may include extrapolating, from the feedback, that the second set of resources 211 is to be allocated to the first object 140a, in response, generating a resource allocation command code 260 that, upon execution by the processor 162 or 122, causes the processor to provision the second set of resources 211 to the first object 140a. In other words, the second set of resources 211 will be physically allocated to the first object 140a when the resource allocation command code 260 is executed. In response, the server 160 may execute the resource allocation command code 260. In some embodiments, the server 160 may deploy the resource allocation command code 260 to the computing device 120a and it executes the resource allocation command code 260. The server 160 learns from the feedback from multiple resource allocation scenarios and updates the weight and bias values of the neural network of the event-specific resource configuration algorithm 180 accordingly to increase the accuracy of future recommendations.

In some embodiments, the server 160 may electronically receive sensor data 144a-n from the sensor circuits 142a-n and use this information (in addition to other information described above) in generating the event-specific resource allocation recommendation 256 for any given object 140. To this end, with respect to the first object 140a, the server 160 may receive the first sensor data 144a from the sensor circuits 142 associated with the first object 140a, where the sensor data 144a indicates operational parameters comprising physical characteristics of the first object 140a (e.g., weight, quantity, inventory, operating conditions, tire pressure reading, etc.) that affects resource consumption with respect to the first object 140a.

In response, the server 160 (e.g., event-specific resource configuration algorithm 180) may extrapolate, from the sensor data 144a, a current resource usage rate 218 associated with the first object 140a. The server 160 (e.g., event-specific resource configuration algorithm 180) may use the information extrapolated from the sensor data 144a (in addition to other information described above) in generating the first event-specific resource allocation recommendation 256. In this process, the server 160 (e.g., event-specific resource configuration algorithm 180) may implement time-series analysis, regression analysis (e.g., Kalman filters) to extrapolate the current resource usage rate 218 for the first object 140a.

In some embodiments, the server 160 may utilize weather data (in addition to other information described above) in generating the event-specific resource allocation recommendation 256 for the object 140a. For example, the server 160 (e.g., via the event-specific resource configuration algorithm 180) may extract, from the weather data, weather conditions in geographical locations where the first object 140a is maintained (e.g., in warehouses associated with entities 130). In response, the server 160 (e.g., via the event-specific resource configuration algorithm 180) may determine that the extracted weather conditions impact the upcoming resource transfers associated with the first object 140a for the future time window 250. Thus, the server 160 (e.g., via the event-specific resource configuration algorithm 180) may adjust the first event-specific resource allocation recommendation 256 based on the predicted impact of the extracted weather conditions. For example, if the server 160 detects that a weather anomaly (e.g., snowstorm) is expected in the geographic region of the warehouse that stores the first object 140a, the server 160 may predict potential transportation delays, inventory shortages, and/or increased resource demand. In response, the event-specific resource configuration algorithm 180 may modify the first event-specific resource allocation recommendation 256 to preemptively allocate resources 211 to the object 140a before the impact of the weather anomaly, notify the entity 130 to increase inventory, etc. Thus, the first event-specific resource allocation recommendation 256 is further based on the determination that the extracted weather condition impacts the upcoming resource transfer associated with the first object 140a.

The server 160 may retrieve and monitor the structured data 152, unstructured data 154, sensor data 144, and other type of data described herein to detect each upcoming event 242, its impact on resource needs and resource supply for each object 140, and dynamically execute resource allocations before the upcoming event 242 impacts the resources for a given object 140. The server 160 may perform similar operations for each object 140 to determine its resource needs and how it is impacted by upcoming events.

The server 160 (e.g., via the event-specific resource configuration algorithm 180) may cross-reference the sensor data 144a-n, unstructured data 152, structured data 154, resource data 134a-n, and historical event impact data to determine the correlation of environmental factors, resource consumption trends, and predicted resource demands for any object 140a-n.

In some embodiments, the server 160 (e.g.. via the event-specific resource configuration algorithm 180) may execute a plurality of simulations to evaluate different resource allocation schemes across the objects 140a-n to, for example, prioritize the resource allocation for the object(s) 140 that are determined to be impacted by the upcoming event 242. In this process, the server 160 may generate multiple resource allocation schemes by modifying resource allocation parameters, such as resource availability, resource consumption rates, resource distributions to objects 140, supply chain constraints per object, and predicted event impact. The server 160 may determine how each resource allocation scheme performs in terms of resource utilization index for each object 140. In each simulation, the server 160 may iteratively adjust the allocation weight for each object 140, the resource distributions across objects 140, time windows for the resource allocations, etc. The server 160 may generate and execute resource allocation command code 260 that follows the logic as in a simulation associated with the highest performance index (e.g., the resource allocation recommendation 256). The embodiments, examples, and operations described herein are not mutually exclusive and can be combined in any suitable way.

### Example method for resource configuration across objects

FIG. 3 illustrates an example flowchart of a method 300 for resource configuration across objects 140a-n, according to some embodiments. Modifications, additions, or omissions may be made to method 300. Method 300 may include more, fewer, or other operations. For example, operations may be performed in parallel or in any suitable order. While at times it is discussed that the system 100, user devices 120, server 160, or components of any of thereof perform some operations, any suitable system or components of the system may perform one or more operations of the method 300. For example, one or more operations of method 300 may be implemented, at least in part, in the form of software instructions 136, 168 of FIG. 1, stored on a tangible non-transitory machine-readable medium (e.g., memory 128, 166 of FIG. 1) that when run by one or more processors (e.g., processor 122, 162 of FIG. 1) may cause the one or more processors to perform operations 302-328.

At operation 302, the server 160 electronically receives a resource allocation metric 176 from a user device 120a, similar to that described in FIGS. 1-2.

At operation 304, the server 160 automatically receives transmission activity data 178 that indicates a set of resource transfer events associated with a plurality of objects 140a-n, similar to that described in FIGS. 1-2.

At operation 306, the server 160 selects an object 140 from among the plurality of objects 140. The server 160 may iteratively select a new object 140 until no object 104 is left for evaluation.

At operation 308, the server 160 accesses the resource consumption data 174 and sensor data 144 associated with the object 140, similar to that described in FIGS. 1-2.

At operation 310, the server 160 extrapolates, from the resource consumption data 174 and optionally other data, an expected resource usage cycle 212 associated with the object 140, similar to that described in FIGS. 1-2.

At operation 312, the server 160 extrapolates, from the sensor data 144 and optionally other data, a current resource usage rate 218 associated with the object 140, similar to that described in FIGS. 1-2.

At operation 314, the server 160 derives, based on the current resource usage rate 218, the expected resource usage cycle 212, sensor data 144, and transmission activity data 178, a future time window 224 in which additional resources 210 will be required for the object 140 to operate without disruption without a preconfigured criteria is met, similar to that described in FIGS. 1-2.

At operation 316, the server 160 generates a first resource allocation recommendation 226 that comprises the derived time window 224 to allocate the additional resources 210 to the object 140, similar to that described in FIGS. 1-2.

At operation 318, the server 160 determines whether to select another object 140. The server 160 selects another object 140 if at least one object 140 is left for evaluation as indicated by the data sharing settings on the edge computing device 120a, similar to that described in FIGS. 1-2. If it is determined that another object 140 is left for evaluation, the method 300 returns to operation 306. Otherwise, the method 300 proceeds to operation 320.

At operation 320, the server 160 generates an aggregated resource allocation and distribution scheme for the plurality of objects 140, similar to that described in FIGS. 1-2. The aggregated resource allocation and distribution scheme (e.g., aggregated resource allocation recommendation 226) may indicate resource allocation, resource quantity, resource type, time window for a respective object 140, and associated entity 130 that provides the respective resource for the object 140.

At operation 322, the server 160 electronically communicates the resource allocation and distribution scheme to the user device 120a, similar to that described in FIGS. 1-2.

At operation 324, the server 160 electronically receives feedback on the resource allocation and distribution scheme, similar to that described in FIGS. 1-2.

At operation 326, the server 160 adjusts the resource configuration (e.g., resource allocation and distribution scheme) according to the feedback, similar to that described in FIGS. 1-2.

At operation 328, the server 160 executes the resource configuration, similar to that described in FIGS. 1-2.

Example method for event-specific resource configuration in response to an upcoming event

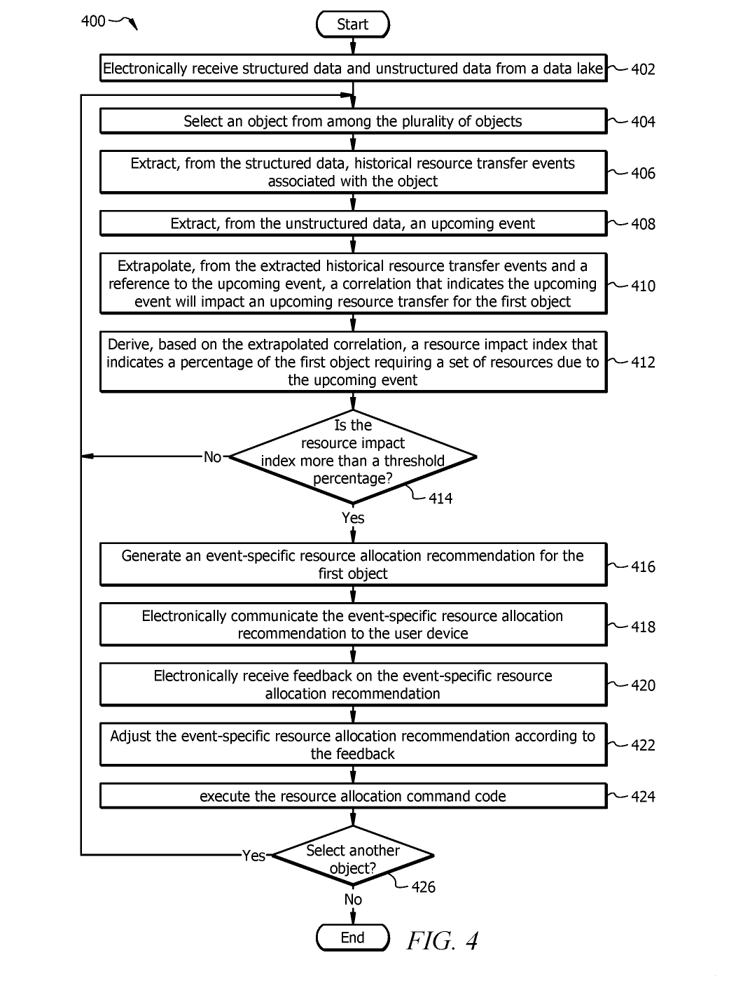

FIG. 4 illustrates an example flowchart of a method 400 for event-specific resource configuration in response to an upcoming event 242, according to some embodiments. Modifications, additions, or omissions may be made to method 400. Method 400 may include more, fewer, or other operations. For example, operations may be performed in parallel or in any suitable order. While at times it is discussed that the system 100, user devices 120, server 160, or components of any of thereof perform some operations, any suitable system or components of the system may perform one or more operations of the method 400. For example, one or more operations of method 400 may be implemented, at least in part, in the form of software instructions 136, 168 of FIG. 1, stored on a tangible non-transitory machine-readable medium (e.g., memory 128, 166 of FIG. 1) that when run by one or more processors (e.g., processor 122, 162 of FIG. 1) may cause the one or more processors to perform operations 402-426.

At operation 402, the server 160 electronically receives structured data 152 and unstructured data 154 from the data lake 150, similar to that described in FIGS. 1-2.

At operation 404, the server 160 selects an object 140 from among a plurality of objects140a-n, similar to that described in FIGS. 1-2. The server 160 may iteratively select an object 140 until no object 140 is left for evaluation.

At operation 406, the server 160 extracts, from the structured data 152, historical resource transfer events 246 associated with the object 140, similar to that described in FIGS. 1-2.

At operation 408, the server 160 extracts, from the unstructured data 154, an upcoming event 242.

At operation 410, the server 160 extrapolates, from the extracted historical resource transfer events 246 and a reference to the upcoming event 242, a correlation that indicates the upcoming event 242 will impact an upcoming resource transfer for the object 140, similar to that described in FIGS. 1-2.

At operation 412, the server 160 derives, based on the extrapolated correlation, a resource impact index 252 that indicates a percentage of the object 140 requiring a set of resources 211 due to the upcoming event 242, similar to that described in FIGS. 1-2.

At operation 414, the server 160 determines whether the resource impact index 252 is more than a threshold percentage 254, similar to that described in FIGS. 1-2. If it is determined that the resource impact index 252 is more than the threshold percentage 254, the method 400 may proceed to operation 416. Otherwise, the method 400 returns to operation 404.

At operation 416, the server 160 generates an event-specific resource allocation recommendation 256 for the object 140, similar to that described in FIGS. 1-2.

At operation 418, the server 160 electronically communicates the event-specific resource allocation recommendation 256 to the user device 120a, similar to that described in FIGS. 1-2.

At operation 420, the server 160 electronically receives feedback on the event-specific resource allocation recommendation 256, e.g., in the message 258, similar to that described in FIGS. 1-2.

At operation 422, the server 160 adjusts the event-specific resource allocation recommendation 265 according to the feedback, similar to that described in FIGS. 1-2.

At operation 424, the server 160 executes the resource allocation command code 260, similar to that described in FIGS. 1-2.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory that stores a data lake that includes structured data and unstructured data, wherein:
the structured data comprises historical resource transfer events associated with a first object, wherein each of the historical resource transfer events indicates a quantity of physical resources consumed with respect to a first object over time; and
the unstructured data comprises news reports, wherein the news reports comprise text that indicates events with respect to one or more geographic locations;
a processor communicatively coupled to the memory, and configured to:
electronically retrieve, via a network and from the data lake, the structured data and the unstructured data;
extract, from the structured data, the historical resource transfer events;
extract, from the unstructured data, an upcoming event, wherein extracting the upcoming event comprises:
convert the text into a tokenized dataset, wherein each word within the text is converted into a respective numerical representation that indicates at least one of a meaning of a respective word or a relationship between the respective word and other words within the text;
extract context of the text based at least in part upon the tokenized dataset; and
determine, based at least in part upon the extracted context, a reference to an upcoming event predicted to occur within a future time window;
extrapolate, from the extracted historical resource transfer events and determined reference to the upcoming event, a correlation that indicates the upcoming event will impact an upcoming resource transfer for the first object;
derive, based at least in part upon the extrapolated correlation, a resource impact index that indicates a percentage of the first object requiring a first set of resources due to the upcoming event;
determine that the resource impact index is more than a threshold percentage;
in response to determining that the resource impact index is more than the threshold percentage:
generate a first event-specific resource allocation recommendation for the first object, wherein the first event-specific resource allocation recommendation comprises a quantity of the first set of resources to be allocated to the first object;
electronically communicate the first event-specific resource allocation recommendation to a user device;
electronically receive an electronic message that indicates feedback on the first event-specific resource allocation recommendation; and
in response to electronically receiving the electronic message, adjust the first event-specific resource allocation recommendation according to the feedback, wherein adjusting the first event-specific resource allocation recommendation comprises:
extrapolate, from the feedback that a second set of resources is to be allocated to the first object;
in response to extrapolating, from feedback, that the second set of resources is to be allocated to the first object, generate an event-specific resource allocation command code that, upon execution, causes the processor to provision the second set of resources to the first object; and
execute the event-specific resource allocation command code.

2. The system of claim 1, wherein extracting, from the structured data, the historical resource transfer events comprise:
parse the structured data to identify an interval between each pair of resource transfer events within the historical resource transfer events;
extract a quantity of resources in each historical resource transfer event within the historical resource transfer events; and
extrapolate a trend in resource transfer based at least in part upon the identified interval between each pair of resource transfer events and the extracted quantity of resources in each historical resource transfer event.

3. The system of claim 1, wherein the processor is further configured to:
electronically receive sensor data from a sensor circuit associated with the first object, wherein the sensor data indicates at least one operational parameter comprising a physical characteristic of the first object that affects resource consumption of the first object; and
extrapolate, from the sensor data, a current resource usage rate associated with the first object, wherein the current resource usage rate indicates a rate of depletion in resource usage by the first object; and
wherein the first event-specific resource allocation recommendation is further based at least in part upon the extrapolated current resource usage rate associated with the first object.

4. The system of claim 1, wherein:
the unstructured data further comprises weather data that indicates a weather condition in one or more geographic locations; and
the processor is further configured to:
extract, from the weather data, a weather condition in a geographic location where the first object is maintained; and
determine that the extracted weather condition impacts the upcoming resource transfer associated with the first object; and
the first event-specific resource allocation recommendation is further based at least in part upon the determination that the extracted weather condition impacts the upcoming resource transfer associated with the first object.

5. The system of claim 1, wherein the upcoming event comprises one of:
a predefined seasonal event; or
a weather related event.

6. The system of claim 1, wherein the first event-specific resource allocation recommendation further comprises the future time window in which the second set of resources is to be allocated to the first object.

7. The system of claim 1, wherein the first event-specific resource allocation recommendation further comprises a recommended entity that provides the second set of resources for the first object.

8. A method comprising:
electronically retrieving, via a network and from a data lake, structured data and unstructured data, wherein:
the structured data comprises historical resource transfer events associated with a first object, wherein each of the historical resource transfer events indicates a quantity of physical resources consumed with respect to a first object over time; and
the unstructured data comprises news reports, wherein the news reports comprise text that indicates events with respect to one or more geographic locations;
extracting, from the structured data, the historical resource transfer events;
extracting, from the unstructured data, an upcoming event, wherein extracting the upcoming event comprises:
converting the text into a tokenized dataset, wherein each word within the text is converted into a respective numerical representation that indicates at least one of a meaning of a respective word or a relationship between the respective word and other words within the text;
extracting context of the text based at least in part upon the tokenized dataset; and
determining, based at least in part upon the extracted context, a reference to an upcoming event predicted to occur within a future time window;
extrapolating, from the extracted historical resource transfer events and determined reference to the upcoming event, a correlation that indicates the upcoming event will impact an upcoming resource transfer for the first object;
deriving, based at least in part upon the extrapolated correlation, a resource impact index that indicates a percentage of the first object requiring a first set of resources due to the upcoming event;
determining that the resource impact index is more than a threshold percentage;
in response to determining that the resource impact index is more than the threshold percentage:
generating a first event-specific resource allocation recommendation for the first object, wherein the first event-specific resource allocation recommendation comprises a quantity of the first set of resources to be allocated to the first object;
electronically communicating the first event-specific resource allocation recommendation to a user device;
electronically receiving an electronic message that indicates feedback on the first event-specific resource allocation recommendation; and
in response to electronically receiving the electronic message, adjusting the first event-specific resource allocation recommendation according to the feedback, wherein adjusting the first event-specific resource allocation recommendation comprises:
extrapolating, from the feedback that a second set of resources is to be allocated to the first object;
in response to extrapolating, from feedback, that the second set of resources is to be allocated to the first object, generating an event-specific resource allocation command code that, upon execution, causes a processor to provision the second set of resources to the first object; and
executing the event-specific resource allocation command code.

9. The method of claim 8, wherein extracting, from the structured data, the historical resource transfer events comprise:
parsing the structured data to identify an interval between each pair of resource transfer events within the historical resource transfer events;
extracting a quantity of resources in each historical resource transfer event within the historical resource transfer events; and
extrapolating a trend in resource transfer based at least in part upon the identified interval between each pair of resource transfer events and the extracted quantity of resources in each historical resource transfer event.

10. The method of claim 8, further comprising:
electronically receiving sensor data from a sensor circuit associated with the first object, wherein the sensor data indicates at least one operational parameter comprising a physical characteristic of the first object that affects resource consumption of the first object; and
extrapolating, from the sensor data, a current resource usage rate associated with the first object, wherein the current resource usage rate indicates a rate of depletion in resource usage by the first object; and
wherein the first event-specific resource allocation recommendation is further based at least in part upon the extrapolated current resource usage rate associated with the first object.

11. The method of claim 8, wherein:
the unstructured data further comprises weather data that indicates a weather condition in one or more geographic locations; and
the method further comprises:
extracting, from the weather data, a weather condition in a geographic location where the first object is maintained; and
determining that the extracted weather condition impacts the upcoming resource transfer associated with the first object; and
the first event-specific resource allocation recommendation is further based at least in part upon the determination that the extracted weather condition impacts the upcoming resource transfer associated with the first object.

12. The method of claim 8, further comprising:
a predefined seasonal event; or
a weather related event.

13. The method of claim 8, wherein the first event-specific resource allocation recommendation further comprises the future time window in which the second set of resources is to be allocated to the first object.

14. The method of claim 8, wherein the first event-specific resource allocation recommendation further comprises a recommended entity that provides the second set of resources for the first object.

15. A non-transitory computer-readable medium storing instructions that when executed by a processor, cause the processor to:
electronically retrieve, via a network and from a data lake, structured data and unstructured data, wherein:
the structured data comprises historical resource transfer events associated with a first object, wherein each of the historical resource transfer events indicates a quantity of physical resources consumed with respect to a first object over time; and
the unstructured data comprises news reports, wherein the news reports comprise text that indicates events with respect to one or more geographic locations;
extract, from the structured data, the historical resource transfer events;
extract, from the unstructured data, an upcoming event, wherein extracting the upcoming event comprises:
convert the text into a tokenized dataset, wherein each word within the text is converted into a respective numerical representation that indicates at least one of a meaning of a respective word or a relationship between the respective word and other words within the text;
extract context of the text based at least in part upon the tokenized dataset; and
determine, based at least in part upon the extracted context, a reference to an upcoming event predicted to occur within a future time window;
extrapolate, from the extracted historical resource transfer events and determined reference to the upcoming event, a correlation that indicates the upcoming event will impact an upcoming resource transfer for the first object;
derive, based at least in part upon the extrapolated correlation, a resource impact index that indicates a percentage of the first object requiring a first set of resources due to the upcoming event;
determine that the resource impact index is more than a threshold percentage;
in response to determining that the resource impact index is more than the threshold percentage:
generate a first event-specific resource allocation recommendation for the first object, wherein the first event-specific resource allocation recommendation comprises a quantity of the first set of resources to be allocated to the first object;
electronically communicate the first event-specific resource allocation recommendation to a user device;
electronically receive an electronic message that indicates feedback on the first event-specific resource allocation recommendation; and
in response to electronically receiving the electronic message, adjust the first event-specific resource allocation recommendation according to the feedback, wherein adjusting the first event-specific resource allocation recommendation comprises:
extrapolate, from the feedback that a second set of resources is to be allocated to the first object;
in response to extrapolating, from feedback, that the second set of resources is to be allocated to the first object, generate an event-specific resource allocation command code that, upon execution, causes the processor to provision the second set of resources to the first object; and
execute the event-specific resource allocation command code.

16. The non-transitory computer-readable medium of claim 15, wherein extracting, from the structured data, the historical resource transfer events comprise:
parse the structured data to identify an interval between each pair of resource transfer events within the historical resource transfer events;
extract a quantity of resources in each historical resource transfer event within the historical resource transfer events; and
extrapolate a trend in resource transfer based at least in part upon the identified interval between each pair of resource transfer events and the extracted quantity of resources in each historical resource transfer event.

17. The non-transitory computer-readable medium of claim 15, wherein the instructions further cause the processor to:
electronically receive sensor data from a sensor circuit associated with the first object, wherein the sensor data indicates at least one operational parameter comprising a physical characteristic of the first object that affects resource consumption of the first object; and
extrapolate, from the sensor data, a current resource usage rate associated with the first object, wherein the current resource usage rate indicates a rate of depletion in resource usage by the first object; and
wherein the first event-specific resource allocation recommendation is further based at least in part upon the extrapolated current resource usage rate associated with the first object.

18. The non-transitory computer-readable medium of claim 15, wherein:
the unstructured data further comprises weather data that indicates a weather condition in one or more geographic locations; and
the instructions further cause the processor to:
extract, from the weather data, a weather condition in a geographic location where the first object is maintained; and
determine that the extracted weather condition impacts the upcoming resource transfer associated with the first object; and
the first event-specific resource allocation recommendation is further based at least in part upon the determination that the extracted weather condition impacts the upcoming resource transfer associated with the first object.

19. The non-transitory computer-readable medium of claim 15, wherein the upcoming event comprises one of:
a predefined seasonal event; or
a weather related event.

20. The non-transitory computer-readable medium of claim 15, wherein the first event-specific resource allocation recommendation further comprises the future time window in which the second set of resources is to be allocated to the first object.
